(19) United States
(12) Patent Application Publication
(10) Pub. No.: US 2002/0155885 A1
(43) Pub. Date: Oct. 24, 2002

(54) Computer systems and methods for on-line user community where users can bet against each other

(76) Inventor: Omer Shvili, New York, NY (US)

Correspondence Address: PENNIE AND EDMONDS, 1155 AVENUE OF THE AMERICAS, NEW YORK, NY, 100362711

(21) Appl. No.: 10/042,517

(22) Filed: Jan. 7, 2002

Related U.S. Application Data
(63) Continuation of application No. 09/636,792, filed on Aug. 11, 2000, now abandoned.
(60) Provisional application No. 60/148,632, filed on Aug. 12, 1999.

(51) Int. Cl. G06F 19/00

(52) U.S. Cl. 463/25

(57) ABSTRACT

In the preferred embodiments, systems and methods for placing bets using Internet/World Wide Web technology are provided. Preferably, a user can either join a pool where a number of people bet on a specific event or can participate in one-to-one betting. If the pool option is selected, the user selects a pool of interest, contributes to the pool, and later receives the proceeds (or a portion thereof), if his/her bet is successful. Furthermore, a user is provided with a capability to define a pool associated with his/her event of interest so that it would be available for the other users to join and bet. If the one-to-one option is selected, a user may either find an existing bet offered by another user and place a counter-bet, preferably also with an option of specifying the odds, or, if no bets of interest are available, a user can define his/her own bet with associated odds. The pool and one-to-one bets are preferably stored in a database allowing all the users to search the database so as to review and identify the bets of interest. Furthermore, preferably users can participate in discussion groups, as generally known in the art of internet services, organized in connection with specific events which are the subject of the bets or pools available through the preferred system. In one preferred embodiment, the system does not use actual money for placing bets. Instead, the bets are placed with non-monetary electronic currency (virtual money). Each user in such a preferred embodiment is provided with a certain number of points in his/her account with the service. This account is decreased or increased according to user's betting results. Periodically the service rewards more successful users.

### FIELD OF THE INVENTION

This invention relates to on-line computer services preferably for betting applications.

### BACKGROUND OF THE INVENTION

Gambling websites are well-known. Such websites imitate a casino or a bookie in electronic form using known Internet World Wide Web (WWW) technology. A user of a gambling website typically gambles on-line against the house which operates the website. As in traditional casinos, user's gambling losses become the profits of an operator of the website which has the odds in its favor. Since user's experience with such gambling websites is not different from gambling at traditional casinos, such websites present all the dangers conventionally associated with gambling.

Since, by nature, people like to bet on the outcomes of various events, it is much more desirable that individuals bet among themselves rather than gamble against a casino (physical or electronic). First, individuals can adjust the odds as they desire (most likely equally) and second, they may place bets on the events of their interest which are likely to be different from the offerings on gambling websites. Individuals conventionally place friendly bets with friends, coworkers, etc. There is, however, a large community, which is outside of reach of a typical person, who may be interested to place bets on the same events as such a person. Thus, it is desirable to provide an on-line service that preferably takes advantage of the Internet/World Wide Web technology so as to enable a large community of people to participate in various bets with respect to various events of interest. Furthermore, typically, the universe of available events in gambling websites is very limited and frequently unrelated to the actual interests of the participants. Thus, there is a need to develop technology that employs on-line capabilities to enable users to define and participate in bets tailored to their interests.

### SUMMARY OF THE INVENTION

In the preferred embodiments, systems and methods for placing bets using Internet/World Wide Web technology are provided. The preferred systems rely on the infrastructure, interfaces, and protocols known in the art of building websites so as to implement the novel betting services of the invention. Preferably, a user interacts with the preferred service using the Internet and a well-known browser on his/her personal computer (or any other device such as an internet appliance) communicating by telephone, cable, cellular, satellite or any other network with the website of the preferred services. The preferred service can employ a client/server architecture, wherein the service is supported by a dedicated application running on a user's computer. Such an application may monitor the website of the service without user's intervention and notify the user about potential events of interest.

The services of the preferred embodiments enable the users to place friendly bets with each other. Unlike electronic casinos, the service operator of the preferred embodiments does not control the odds of the bets and does not gamble against the users of the preferred website. Instead, only a transaction or membership fee is charged by the preferred services. Alternatively, no fee is charged at all, and the revenues are generated using on-line advertisements as well-known in the art of internet services. In addition, the preferred embodiments facilitate interaction between the users who are interested to bet on a given event. The preferred embodiments also provide information about various events of interest to the users who wish to bet on such events.

Preferably, a user can either join a pool where a number of people bet on a specific event or can participate in one-to-one betting. If the pool option is selected, the user selects a pool of interest, contributes to the pool, and later receives the proceeds (or a portion thereof), if his/her bet is successful. Furthermore, a user is provided with a capability to define a pool associated with his/her event of interest so that it would be available for the other users to join and bet. If the one-to-one option is selected, a user may either find an existing bet offered by another user and place a counter-bet, preferably also with an option of specifying the odds, or, if no bets of interest are available, a user can define his/her own bet with associated odds. The pool and one-to-one bets are preferably stored in a database allowing all the users to search the database so as to review and identify the bets of interest. Furthermore, preferably users can participate in discussion groups, as generally known in the art of internet services, organized in connection with specific events which are the subject of the bets or pools available through the preferred system.

In one preferred embodiment, the system does not use actual money for placing bets. Instead, the bets are placed with non-monetary electronic currency (virtual money). Each user in such a preferred embodiment is provided with a certain number of points in his/her account with the service. This account is decreased or increased according to user's betting results. Periodically the service rewards more successful users.

### BRIEF DESCRIPTION OF THE DRAWINGS

FIG. 1 is a flowchart of software supporting the betting service of the preferred embodiment.

FIG. 2 is a flowchart of software for financial processing in connection with a pool option in the preferred embodiment that employs money.

FIG. 3 is a flowchart of software for financial processing in connection with a one-to-one option of the preferred embodiment that employs money.

FIG. 4 is a flowchart of software supporting user's definition of a bet.

### DETAILED DESCRIPTION OF THE PREFERRED EMBODIMENT

The preferred system and method provides a service described below over a computer network (e.g., Internet). The preferred service enables its users to place bets on various events of interest, interact with each other, and obtain information about the events. The software of the preferred service is primarily implemented on a server that employs WWW/Internet technology and implements a website of the service. In general, websites are known in the art. The server communicates with user's devices which can be any computer devices that support communication over the Internet or another computer network and preferably include software for receiving, reading, and interacting with web pages, such as web browsers. As known in the art, the preferred server provides web pages to a user interacting with the service based on the information communicated by the user. The server is a computer that can range from a personal computer to a work station or a larger computer depending on the demands of a specific implementation. It can also be implemented as several networked computers. The server stores at least one database as discussed below supported by database management software as known in the art. It also includes other software as further described below and other known software typically employed for supporting such servers. In the preferred embodiment, the software implementing the service is resident on the server and the user computers use Internet browsers to interact with the service provided by the server. In other embodiments additional functionality can be implemented at the user computers. For example, a client server/architecture, wherein a dedicated application is provided on a user's computer, can be employed.

As noted, the present service enables users to interact with each other, learn about various events of interest, and bet against each other on the outcomes of the selected events. The preferred service is not similar to the known gambling websites. Such gambling websites imitate a casino or a bookie in an electronic form. As in traditional casinos, the users of electronic gambling websites gamble against the house, which is the operator of the website. In contrast, the website of this service does not support such gambling. Instead, it enables its users to place friendly bets with each other. Unlike in electronic casinos, the service operator of the preferred embodiment does not control the odds of the bets and does not gamble against the users.

Thus, the operator of the website of the preferred embodiments cannot win any bet placed through the preferred service. Instead, the site of one preferred embodiment charges its users only for using the services. The charges can be computed as a percentage of the amount payed to the winner(s) of a given bet or it can be a flat fee collected for betting on a given event, or a flat membership fee, or the preferred service may be offered for no charge (in this case the service operator generates revenue only from the advertisements offered on the site as known in the art). As noted, in addition to the betting capability, the site also maintains communities in which users may interact with each other and obtain information about the events of interest, e.g., about sporting games. Thus, the site of the preferred embodiment uniquely maintains on-line communities of users who are interested in specific events to the extent that they are ready to place bets on these events. Accordingly, the preferred service facilitates interaction among people with similar interests. It is apparent that the approach of the preferred embodiment is dramatically different in its intent and execution from gambling web sites in which isolated individuals gamble against the operator of the site who benefits from the losses of the participants. On the contrary, the preferred service facilitates user interaction and does not benefit from any losses of its users.

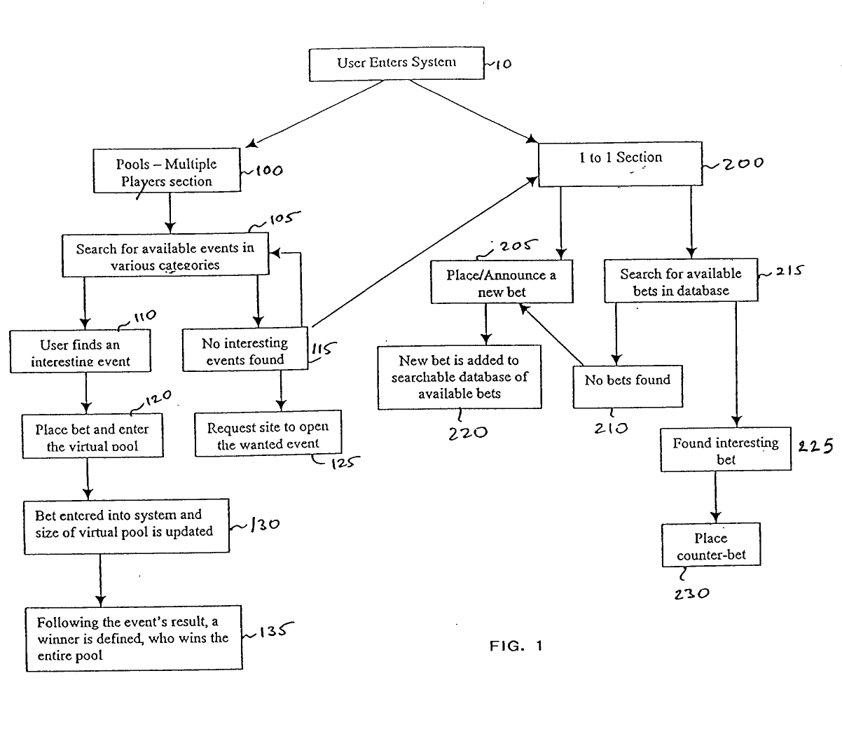

Referring to FIG. 1, after a user has logged onto the service over the Internet as known is the art, he/she is provided with an introductory screen that allows a user to select an option to join “pools” involving multiple users or another option of betting against another individual. See 10. More specifically, the pool option allows multiple participants to contribute money to a pool and to make a bet on the outcome of an event associated with the pool (e.g., who will be a winning team of a game); the person(s) who guessed correctly receive(s) the entire amount in the pool (less service fee, if any). The second option is referred to as the one-to-one or user-to-user option and it supports bets between two people on the opposite sides of the bet.

If the pool option has been selected, see 100, the user is provided with a list of categories from which he/she can select an event of interest that has an associated pool. The categories of such events may include sporting events, political events, stock market events, weather, local events, and other categories. The categories may include subcategories, e.g., basketball, tennis, etc. may be included under the “sports” category.

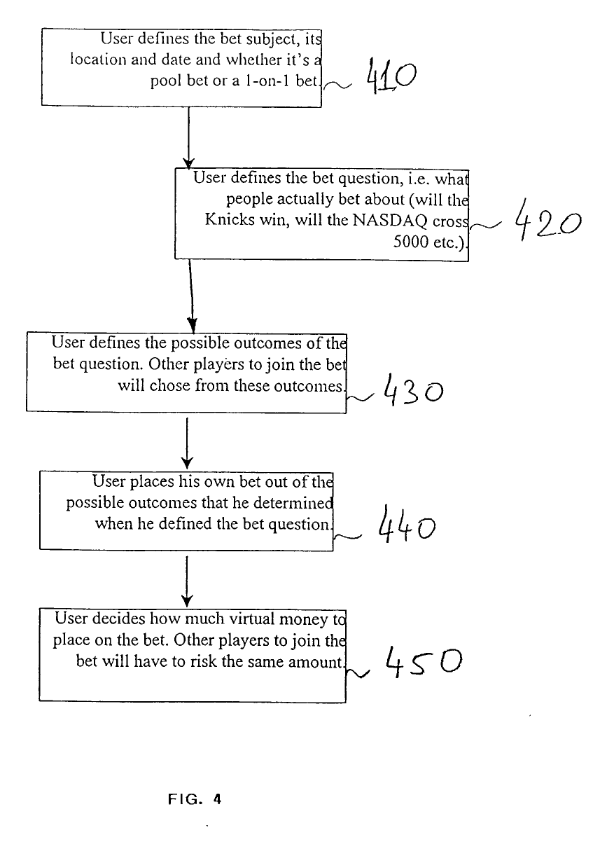

After the user has selected the desired category (and subcategory), he/she is presented with a list of events that have associated pools. At this point, the user can search and review these events and the associated pools. See 105. If the user does not find an event of interest, the user may send a message to the system administrator suggesting to establish a pool for the event that the user finds interesting. See 115 and 125. In response, the preferred service may open a pool for the requested event, or, if the administrator believes that the suggested event would not be of interest to the other participants, the user suggesting to create such a pool is offered to participate in the user-to-user betting or to define a “customized” pool. To set up such a customized pool, the user selects this option and receives a form from the system where the user can define the poll by specifying the event that forms the basis of the poll, the condition for winning, the amount of the bets, and possibly other parameters. (See, also, FIG. 4 and related discussion). Thereafter, the pool is added to the list of pools supported by the system provided that the system verified and approved the user's choices. For example, the condition of winning the pool identified by the user should be verifiable by the system.

If at 105 the user finds an interesting event, he/she may select this event and in response the system provides a web page associated with the corresponding pool. At this point, the user may choose to joint the pool, contribute money into the pool, and specify the outcome that he/she is betting on. See 110 and 120. The outcome(s) that the user can bet on as well as the amount of the pool bets are specified on the web page associated with the selected pool. As noted, in addition to the capability to make a bet, the page associated with the selected event manages a community of users interested in the event and participating in the pool. The names (or user ID's or “handles”) of the people currently participating in the pool can be displayed and the user can select a displayed name and establish an electronic communication with one of the participants of the pool by selecting his/her name, as known in the art. Discussion forums and information of general nature about the event are also provided in association with the pool. Such information associated, for example, with a sporting event may include data and articles about the teams involved, statistics, profiles of the players, etc. The system may also provide programming related to the event, for example, the game can be shown on the site of the preferred embodiment to the users who entered the pool relating to the game.

Different pools can be associated with a given event. For example, for a sporting event, the pools may contain bets on a particular score, or on which team is going to score first, or on who is going to win. For example, for a sporting event, a pool may be configured by the system (or by a user) to include multiple games as frequently done in the office pools or a pool may include a single game. The pools can be organized at various times in relation to the associated event. For example, a new pool can be organized when a sporting event has already begun.

When a user enters the pool before he/she places a bet, he/she is provided with data concerning the pool, including the number of people in the pool, and a calculator that determines potential winnings at a given time for a given bet. As noted, the user is also provided with handles (names) of the other users participating in the pool and can select them in order to interact with the other users. In addition, message boards, chart rooms, emails and other on-line tools known in the art may be provided.

At 130 the user enters his/her bet and in response the system updates the size of the pool and the list of its participants. The system receives preferably a real-time feed of information relating to various events from external sources. For example, it can receive real-time data relating to the scores of sporting event, stock-market-related prices, data relating to political events, and other data relating to the events of interest. This information is preferably received from commercial distributors of such information as known in the art. The received data is stored in the system database and is periodically checked to ascertain whether any of the events associated with the pools have resulted in the outcomes sufficient to ascertain the winner(s). If so, the system determines the winner(s) of the entire pool and notifies the pool participants appropriately. See 135.

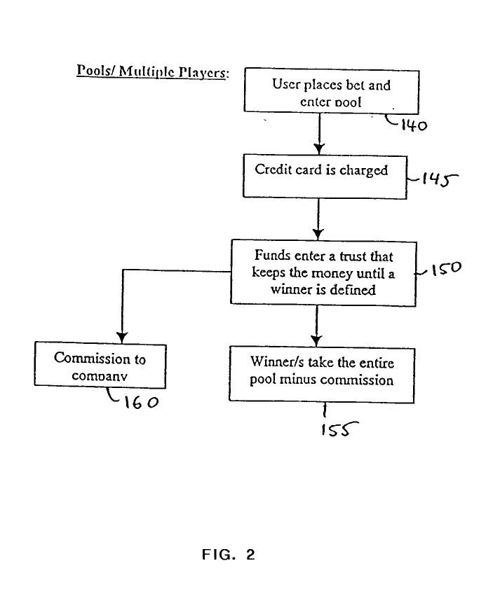

FIG. 2 illustrates financial processing by the preferred system in connection with the pool option discussed above. At 140 the user places a pool bet as discussed above. The amount that the user must pay to join a given pool is specified by the service in connection with the pool for the selected event. (It can also be specified by a user who establishes a customized pool). At this point the credit card of the user is charged by the system in the amount specified for the pool. This is done using secure software processing as known in the art. See 145. Alternatively, the system may maintain an account for the user where the user previously deposited his/her funds. Then, the amount associated with the bet can be subtracted from this account. At 150, the funds provided by the user are electronically added to an account maintained by the service in connection with the pool. This account of the service holds all the money paid by the participants of the pool until the winner is determined. In some embodiments, such an account may be maintained by a third party.

Thereafter, the service subtracts its commission from the collected funds for the pool. The commission can be a percentage of the funds or a flat fee as discussed above. See 160. The commission is credited to the account of the service. Alternatively, this step may be unnecessary if the service does not charge users for bets but instead relies on other sources of revenue, for example, on the fees payed by advertisers or membership fees as known in the art. As illustrated at 155, the money in the account associated with the pool (reduced by the commission, if any) is then credited to the credit card(s) of the winner(s) or added to the account(s) of the winner(s) maintained by the service. Alternatively, the funds can be wired to the account(s) of the winner(s) or check(s) can be issued and mailed. If there are several winners for a given pool, preferably, the funds associated with the pool are divided equally among the winners, or in accordance with any other formula adopted by a specific pool.

Returning to FIG. 1, instead of choosing an option to join one of the pools, a user may choose a one-to-one betting option where the user himself or herself defines the betting event, the amount of the bet and possibly its other characteristics, such as the odds of the bet. This option is selected at 200. After selecting the one-to-one betting option at 200, the user is provided with an appropriate page where he/she can either announce a new bet, see 205, or search the database of existing one-to-one bets originated by the other users of the service. (See 215).

If the user selects an option of announcing a new bet, in response, the service provides to the user an electronic form where the user can define the proposed bet. In filling out this electronic form, the user must specify the event associated with the one-to-one bet, which can be selected from the database maintained by the service that includes a wide variety of events for which the system can receive a verifiable determination of the outcome. Thus, the user reviews the entries in the database and selects the desired event. Alternatively, the user may specify an event that is not a part of the database. It should be noted that this one-to-one option allows users to place bets on various events that are typically are not a subject of bets. For example, local sporting events or local politics may be used to define the events.

Then the user enters the amount of the bet and optionally may enter the odds that he/she is willing to accept. For example, the user may specify that for his/her $20 he/she would accept a $10 counter-bet. Other features of the one-to-one bet may be specified by the user, such as a user-defined criteria for verifying the outcome. In addition, the user specifies the subject category of the bet since the one-to-one bets are stored in the database classified by their subject matter categories, e.g., sporting events, politics, local events, etc. Also, a sub-category can be used. In filling out the form, the user also confirms that he/she will be bound by the determination of the service regarding the outcome of the bet (i.e., who is the winner) if there is a dispute. After the user has specified the bet, this information is transmitted to the system. After the information has been validated, the system adds the new bet to its database. See 220.

After the bet has been entered and stored in the database, another user can find it when reviewing the database entries for one-to-one bets and bet against the user who placed the original bet. As noted, the users are provided with a capability of searching or browsing the database of entered bets as illustrated at 215 using searching technologies known in the art. Because the bets are organized by subject matter, the user who wants to join an existing bet first selects the subject matter and then searches the corresponding bets. If, as a result of the search, the user finds an interesting bet, he/she selects this bet and indicates that he/she wants to place a counter-bet, see 225 and 230. The user may also define his/her own bet as discussed above (see 205). The user does not need to examine the existing bets before offering his/her own bet. The user may ignore the existing bets and begin using the one-to-one option by offering his/her bet.

In reviewing the database entries for the existing bets, the user can select either a bet where no counter-bet has been entered or a bet where a counter-bet has already been entered. If the user selects a bet that already has a counter-bet, he/she can raise the odds by offering more money than the amount of the current counter-bet. Thus, in essence, the system provides an auction of bets and counter-bets.

For example, a user searches the database for the subject matter of interest and finds a bet that does not have a counter-bet. He/she then can counter-bet on the terms defined by the user offering the bet. Subsequently, a second user wants to bet on the same event and is ready to bet more than the original bet. For example, if the original bet and counter-bet were $100 each, the second user may offer a $110 counter-bet. In this case the second user replaces the original user, who offered the original counter-bet, as a party to the bet and the amount of the counter-bet becomes $110. Thus, at this point, the user who placed the bet would lose only $100 if he/she loses the bet, but would win $110 because the counter-bet was increased to this amount. After the outcome of the event, which is the subject of the bet has been determined, the winner receives the money of both parties reduced by the service fee, if any.

The user who places a counter-bet also agrees to comply with the decision of the system administrator regarding the outcome of the bet. Thus, if two users disagree regarding the outcome of a given bet, the preferred service has the authority to make the determination regarding who is the winner. For this reason the service may disallow certain bets for the events that it cannot verify.

The system also rates the users on how successful they are in betting. That is, the users who frequently win have better ratings. A high rating may facilitate an active “social life” of the user on the site since the others may want to communicate with such a user with a high rating in order to discuss the relevant events.

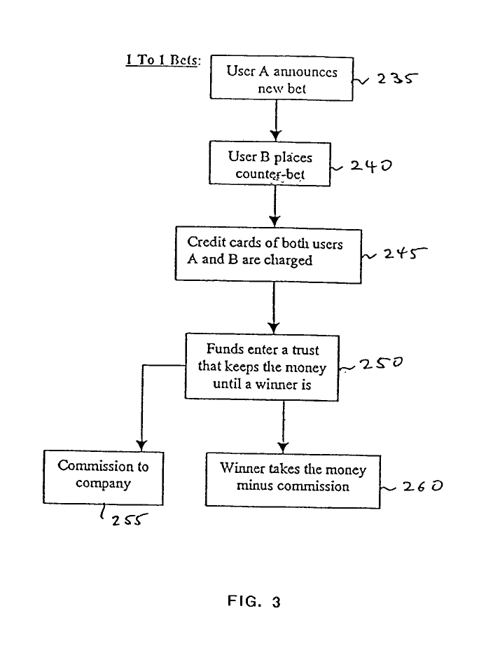

FIG. 3 illustrates how the funds are processed for the one-to-one option. As discussed above, at 235, user A announces a new bet and then at 240 user B places a counter-bet. At this point, credit cards of both users are charged and the funds are deposited in an account maintained by the service. See 245 and 250. Alternatively, the user account(s) associated with the service may be debited appropriately. Then at 260, after the winner of the bet has been determined, the winner receives the funds of both players that have been held by the service reduced by the commission of the service, if any. As discussed above, the commission can be computed on the percentage basis, or can be a flat fee. See 255.

As noted, in an alternative preferred embodiment, the service does not employ any actual money. Instead, when a user joins the service, the system administration opens an electronic on-line account for the user consisting of a certain amount of electronic non-monetary currency (virtual money) maintained by the system for the users to place non-monetary bets. Thus, the users can use the system for bets substantially as described above but without any use of the money. The bets in this embodiment are placed with virtual money. Accordingly, the functions in accordance with the flowchart of FIG. 1, but the flowcharts of FIGS. 2 and 3 are unnecessary in this embodiment since the system of this embodiment does not use actual money. The system of this embodiment adds or subtracts virtual money from the non-monetary accounts depending on user's performance on the bets.

Accordingly, when a user enters a pool, see blocks 100-135, the contributions to the pool are made using this non-monetary currency, e.g., points, of the users. Otherwise, the flow of control is the same as illustrated in the blocks of FIG. 1 relating to the pool option. As noted, unlike office pools and soccer pools (popular in Europe), where the pool is almost always set for a series of events/games (in Europe the pools contain about 15 soccer games in each pool), the pools of the preferred embodiments can be set for both a single event (e.g., a sporting game) or multiple events (e.g., games). Both single and multiple event/game pools can be provided in the embodiments that use actual and virtual money. Also, as noted, when a user finds an interesting event associated with a pool by searching the system database of such events, he/she can place a bet and enter the corresponding pool. Before he/she does so, he/she can see the relevant data concerning that pool, including: the number of people in the pool, the amount of virtual (or real) money in that pool and other relevant information. A user can also display the handles (nicknames) of the other users in the pool and interact with them, using message boards, chat rooms, e-mail and other tools as known in the art. If a user does not find an interesting event associated with existing pools, he/she may define such a pool.

Similarly, in the one-to-one betting as illustrated using blocks 200-230, this preferred embodiment uses virtual money. As noted, in the one-to-one section of the site, a user can offer a bet to the other members of the site. The user identifies the event he/she wishes to place a bet on, specifies the bet (e.g., which team will win), the amount of virtual money he/she is willing to bet and optionally the odds being offered on the bet. After the bet is defined, it is entered in the one-to-one searchable database, which can be searched by the other users for bets in various categories. Thus, the user determines the event, the win/lose criteria and the odds he/she is willing to place on the event. As noted, in the one-to-one section, users can search through the database for bets that interest them. After finding such a bet, a user can place a counter-bet. When placing a counter-bet, the user accepts the terms of the bet as defined by the user who offered that bet. Also, as described above, an auction-like feature allows a user to see a bet that already has a match (a counter-bet), and offer better terms to the user that offered that bet. For example, if user A announces a bet in which he/she offers 100 points of virtual money on the Knicks vs. Pacers, and user B places a counter-bet (100 points on the Pacers), user C can offer better odds to user A, by placing, for example, 110 points on the Pacers versus A's 100 points. The B's counter-bet is then replaced by C's higher bet. In this case user A can win 110 points but only lose the 100 points that he/she offered.

The virtual money that users win or lose as a result of the bets placed through the system are added or subtracted from their non-monetary accounts accordingly. Thus, users that are more successful in bets accumulate a larger number of points in their non-monetary accounts held by the system. Periodically, e.g., weekly or monthly, the system of the preferred embodiment traverses these accounts, rates the users based on their success, and awards various prizes to the users with higher ratings. Thus, in this preferred embodiment, no money is ever used and this preferred service is merely a game where more successful users may win prizes.

FIG. 4 illustrates in greater detail how a user defines a new bet. This process is applicable to the embodiment that employs actual money and to the embodiment that uses virtual money. As illustrated in FIG. 4, first the user specifies on an electronic form provided by the server, the subject matter of the bet and the associated location and date as well as whether it is a pool or a one-to-one bet. Thereafter, as illustrated at 420, the user defines the actual bet question, e.g., whether Nicks would win a certain game or whether Nasdaq would exceed 5,000 and the like. Next, the user defines possible outcomes of the bet question. Other players will be able to select one of these outcomes and bet on it. See 430. Thereafter, as illustrated at 440, the user places his/her own bet on one of the previously identified possible outcomes. Then, as indicated at 450, the user associates an amount of money or virtual money that he/she and the other users should bet in connection with the defined bet. Also, in some embodiments users may bet different amounts depending on the odds and the other considerations discussed above. If all the data specified for the bet is proper, as verified by the server, the bet is added to the database of the service for other users to locate and bet on it.

As discussed above, the preferred services stores relevant information in connection with the bets in its database. To identify events of interest, preferably, the system receives a real-time feed from news source(s) relevant to the events of the bets, for example, from a sports network or business-related network. The software of the service parses the received data and identifies the events. For example, sports teams are assigned codes by the network supplying the information. The parsing software of the server identifies these codes based on the format of a particular feed and interprets them consistently with the codes or other data representation used by the database of the service. Then, based on the identified input, the software searches the database and when the entry relating to this event is found, the software registers the outcome in connection with this event.

In addition to obtaining the relevant event data from external sources, the system may employ a “web crawler” software. In one implementation it contains a list of URL's of the sites that may contain information pertinent to the events of interest. The web crawler software contacts these sites, interprets the HTML or other format of the sites so as to ascertain the information relevant to the events of interest. Thereafter, the information regarding such events is provided to the preferred service and registered in the database.

As noted, the present system may employ a dedicated software application installed on user's computers as known in connection with client/server systems. Such a dedicated application is typically downloaded on a user's computer from the server and is used to support the present service. In this client-server environment, the dedicated software application on a user's computer may periodically contact the server and, for example, notify the user if a bet of interest has been placed or if there are individuals on-line using the service who are of interest to the user. Thus, in this embodiment the user is essentially connected to the service of the present invention all the time and may instantly react to the events of interest. Thus, for example, users may be automatically alerted about the bets in the area of interest specified by the user. Furthermore, in this embodiment, users would be enabled to readily communicate with each other and, for example, negotiate their bets.

As noted, the preferred embodiments can be implemented as an Internet-based system. It can also be implemented using an intranet connecting the users to the server as known in the art. Such an intranet may not be accessible by everybody, unlike the Internet. For example, a number of hotels in Nevada can be connected by such an intranet or a separate network (intranet) can be provided within a given hotel.

The present invention is not to be limited in scope by the specific embodiments described herein. Indeed, modifications of the invention in addition to those described herein will become apparent to those skilled in the art from the foregoing description and accompanying figures. Doubtless, numerous other embodiments can be conceived that would not depart from the teaching of the present invention, whose scope is defined by the following claims.

1. A computer system supporting a betting service, wherein users communicate with the system over a network, comprising:
means for a user to search for an event,
means for a user to join a pool associated with the event, and
means for determining at least one winner of the pool associated with the event.

2. The system of claim 1 further comprising means for enabling a user to organize a new pool.

3. The system of claim 1 wherein the network is the Internet.

4. The system of claim 1 further comprising means for providing discussion groups to users who joined the pool associated with the event.

5. The system of claim 1 further comprising means for providing information to the user concerning the event on a web page associated with the pool.

6. The system of claim 1 further comprising a database storing events associated with pools.

7. The system of claim 1 further comprising means for displaying identities of people who entered the pool.

8. The system of claim 1 further comprising an electronic accounts of users comprising virtual money.

9. The system of claim 8 wherein one or more winners of the pool receive at least a portion of the virtual money in the pool, which virtual money is then credited to the account of the one or more winners.

10. The system of claim 1 wherein the user communicates with the service using a dedicated program stored on user's computer.

11. The system of claim 1 further comprising means for rating users and awarding prizes to users who rated higher than other users of the service.

12. The system of claim 1 further comprising means for providing an option to place one-to-one bets between two users.

13. The system of claim 1 further comprising means for receiving data from an external source regarding the event.

14. A computer system providing betting service for users interacting with the system over a network comprising:
means for a first user to enter a one-to-one bet in connection with an event,
means for a second user to search a database of bets and identify the bet entered by the first user,
means for the second user to enter a counter-bet, and
means for crediting funds associated with the bet to a user who won the bet.

15. The system of claim 14 wherein the network is the Internet.

16. The system of claim 14 wherein one-to-one bets stored in the database are classified by categories.

17. The system of claim 14 further comprising means for storing the counter-bet in the database in association with the bet.

18. The system of claim 14 further comprising means for a third user to place a higher counter-bet than the second user thereby displacing the second user.

19. The system of claim 14 wherein administration of the system determines who won the bet in the event that a party to the bet disagrees with the outcome.

20. The system of claim 14 wherein the funds used in the bet are virtual money.

21. The system of claim 20 wherein users of the service are provided with accounts comprising virtual money.

22. The system of claim 21 further comprising means for rating the users of the service depending on their success in betting, and awarding prizes to users with higher ratings than other users.

23. The system of claim 14 further comprising means for enabling the first user to define the event associated with the bet.

24. The system of claim 14 wherein the users communicate with the service using dedicated programs stored on users' computers.

25. A computer system for a betting service for users communicating over the network with the system comprising:
means for providing a user with an option to enter a pool or one-to-one betting;
means for a user to place a bet using virtual money;
means for determining outcome of an event associated with the bet, and if the user won the bet, crediting virtual money associated with the bet to user's account; and
means for rating the users in accordance to their success in betting using the service.

26. The system of claim 25 further comprising means for awarding prizes to users with higher success in betting.

27. The system of claim 25 wherein the network is the Internet.

28. The system of claim 25 further comprising means for enabling a user to organize a new pool.

29. The system of claim 28 further comprising electronic discussion groups in connection with the pool.

30. The system of claim 28 further comprising means for listing identities of people who entered the pool.

31. The system of claim 25 further comprising means for enabling a user to list one-to-one bets and pools.

32. The system of claim 25 further comprising means for a user to place a counter-bet in one-to-one betting.

33. The system of claim 32 further comprising means for another user to place a counter-bet higher than a previous counter-bet thereby displacing the user who placed the previous counter-bet as a betting party.

34. The system of claim 25 wherein the user communicates with the service using a dedicated program stored on user's computer.

35. A computer method supporting a betting service, wherein users communicate with a computer system over a network, comprising:
enabling a user to search the database for an event,
enabling a user to join a pool associated with the event, and
determining at least one winner of the pool associated with the event.

36. The method of claim 35 further comprising enabling a user to organize a new pool.

37. The method of claim 35 wherein the network is the Internet.

38. The method of claim 35 further comprising providing discussion groups to users who joined the pool associated with the event.

39. The method of claim 35 further comprising providing information to the user concerning the event on a web page associated with the pool.

40. The method of claim 35 further comprising storing events associated with pools in the database.

41. The method of claim 35 further comprising displaying identities of people who entered the pool.

42. The method of claim 35 further comprising depositing virtual money in user's electronic account.

43. The method of claim 42 wherein the pool is comprised of electronic virtual money.

44. The method of claim 9 wherein one or more winners of the pool receive at least a portion of the virtual money in the pool which virtual money is then credited to the account of the one or more winners.

45. The method of claim 35 further comprising rating users.

46. The method of claim 45 further comprising awarding prizes to users who were rated higher than other users of the service.

47. The method of claim 35 further comprising providing an option to place one-to-one bets between two users.

48. A computer method for providing betting service for users interacting with a computer system over a network comprising:
enabling a first user to enter a one-to-one bet in connection with an event,
enabling a second user to search a database of bets and identify the bet entered by the first user,
enabling the second user to enter a counter-bet, and
crediting funds associated with the bet to a user who won the bet.

49. The method of claim 48 wherein the network is the Internet.

50. The method of claim 48 wherein one-to-one bets stored in the database are classified by categories.

51. The method of claim 48 further comprising storing the counter-bet in the database in association with the bet.

52. The method of claim 48 further comprising enabling a third user to place a higher counter-bet than the second user thereby displacing the second user.

53. The method of claim 48 further comprising determining by system administration who won the bet in the event that a party to the bet disagrees with the outcome.

54. The method of claim 48 wherein the funds used in the bet are virtual money.

55. The method of claim 54 wherein users of the service are provided with accounts comprising virtual money.

56. The method of claim 55 further comprising rating the users of the service depending on their success in betting using the service.

57. The method of claim 56 further comprising awarding prizes to users with higher ratings than other users.

58. The method of claim 48 further comprising enabling the first user to define the event associated with the bet.

59. A computer method for a betting service provided to users communicating over a network with the computer system comprising:
providing a user with an option to enter a pool or one-to-one betting;
enabling a user to place a bet using virtual money;
determining outcome of an event associated with the bet, and if the user won the bet, crediting virtual money associated with the bet to user's account; and
means for rating the users in accordance to their success in betting using the service.

60. The method of claim 59 further comprising awarding prizes to users with higher success in betting.

61. The method of claim 59 wherein the network is the Internet.

62. The method of claim 59 further comprising enabling a user to organize a new pool.

63. The method of claim 62 further comprising electronic discussion groups in connection with the pool.

64. The method of claim 62 further comprising means for listing identities of people who entered the pool.

65. The method of claim 59 further comprising enabling a user to list one-to-one bets and pools.

66. The method of claim 65 wherein the available one-to-one bets and pools are organized by subject matter categories.

67. The system of claim 59 further comprising enabling a user to place a counter-bet in one-to-one betting.

68. The system of claim 67 further comprising enabling another user to place a counter-bet higher than a previous counter-bet thereby displacing the user who placed the previous counter-bet as a betting party.
